(19) United States
(12) Patent Application Publication
(10) Pub. No.: US 2004/0030780 A1
(43) Pub. Date: Feb. 12, 2004

(54) Automatic search responsive to an invalid request

(75) Inventor: Glen R. Walters, Hollywood, FL (US)

Correspondence Address: Gregory A. Nelson, Akerman Senterfitt, Fourth Floor, 222 Lakeview Avenue, P.O. Box 3188, West Palm Beach, FL, 33402-3188, US

(73) Assignee: International Business Machines Corporation, Armonk, NY

(21) Appl. No.: 10/214,821

(22) Filed: Aug. 8, 2002

(51) Int. Cl. G06F 15/173; G06F 15/16; G06F 17/30; G06F 7/00

(52) U.S. Cl. 709/225; 709/219; 707/4

(57) ABSTRACT

A method for responding to a request from a client can include determining whether the request received from the client is valid. If the request is invalid, at least one portion of a resource identifier specified by the request can be identified as a search term. The method also can include searching for a computer resource associated with the at least one portion of the resource identifier specified by the invalid request.

### BACKGROUND OF THE INVENTION

1. Technical Field

The present invention relates to the field of data processing, and more particularly, to a method for receiving and validating user input requesting a computer resource.

2. Description of the Related Art

Presently, users can access resources over a network such as the Internet by placing a resource identifier into an address field of a browser. For example, by inserting a resource identifier such as a uniform resource indicator (URI) or a uniform resource locator (URL) into the address field, users can access selected computer resources such as programs, markup language and other electronic documents, multimedia files, and/or any other software object accessible over a network such as the Internet and/or World Wide Web. Because of the enormous amount of information available on the Internet and the tremendous number of possible directory configurations, a resource identifier can be a lengthy character string.

If any portion of the entered resource identifier does not match the address of an existing resource, the server typically responds with an error message such as a Hypertext Transfer Protocol (HTTP) 404 error message. Servers can be programmed to redirect a user to one or more alternate URIs responsive to receiving an invalid resource identifier in a client request. Such URIs can reference Web pages which notify the user of the error and provide hyperlinks to top-level sections of a Web site or to other computer resources, thereby enabling the user to begin searching for the desired resource using a top-down, trial and error approach. This redirection technique, however, can frustrate a user as many Web sites include a vast amount of hyperlinks, directories, and subdirectories which the user must investigate. In consequence, the user may become impatient and terminate the search, never having found the desired resource.

Moreover, for redirection to work properly, an administrator must program rules specifying that incorrect resource identifiers, for example “http://www.ibm.com/thinkpad/”, are equivalent to correct resource identifiers such as “http://www.pc.ibm.com/us/thinkpad/.” Accordingly, to successfully redirect a user to a correct and intended URL after receiving an incorrect resource identifier, the administrator must successfully anticipate every possible user error when entering resource identifiers. As every conceivable erroneous resource identifier cannot reasonably be anticipated, redirection techniques do not provide a solution for resolving erroneous or invalid resource identifiers in every case.

### SUMMARY OF THE INVENTION

The invention disclosed herein provides a solution for resolving invalid resource identifiers, for example, those that specify an incorrect or an expired computer resource address, within a server. In particular, a server can provide one or more alternate resource identifiers which relate to the invalid resource identifier. The server can initiate a search for the user intended computer resource, or for other computer resources which are relevant to the invalid resource identifier. Notably, the search can be performed using one or more terms which are extracted from the invalid resource identifier, thereby assuring that the computer resources determined from the search are relevant to the user desired computer resource.

One aspect of the present invention can include a method for responding to a request from a client. The method can include determining whether the request received from the client is valid. For example, a determination can be made as to whether a resource identifier such as a uniform resource identifier (URI) or a uniform resource locator (URL) specified by the request identifies an existing computer resource. If the request is invalid, at least one portion of the resource identifier specified by the request can be identified as a search term. For example, a portion in the resource identifier following a leftmost forward slash (/) that is not immediately adjacent to another forward slash can be identified. Alternatively, a portion in the resource identifier following a Web extension can be identified. Notably, the identified portion of the resource identifier can be validated using a dictionary specifying valid search terms.

The portion of the resource identifier can be provided to one or more search engines. The search engine, or engines, can use the selected portion as a keyword in a search. Still, the method can include identifying one or more portions of the resource identifier and providing those portions to a search engine. For example, a first and a second portion of the resource identifier can be identified as search terms such that the first portion and the second portion can be combined with an operator to form a search expression for the search.

The first portion and the second portion can be associated with respective weighting factors for performing the search. The weighting factors can be determined by a location of the respective selected portions in the resource identifier. Alternatively, the weighting factors can be determined by a specificity of at least one term in the selected portions.

In any case, the method can include searching for a computer resource associated with one or more identified portions of the resource identifier. Notably, the search can be confined to a domain specified by the resource identifier of the invalid request or can be confined to a server having received the invalid request. One or more computer resources associated with the identified portion of the resource identifier can be identified responsive to the searching step. Accordingly, one or more of the identified computer resources, or the computer resource identifiers associated with the identified computer resources, can be sent to the client for presentation.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 shows an exemplary uniform resource identifier (URI) having portions therein that can be used in a search in accordance with the present invention.

FIG. 2 is a flow chart illustrating a method of searching based upon an invalid resource identifier in accordance with the inventive arrangements disclosed herein.

### DETAILED DESCRIPTION OF THE INVENTION

The invention disclosed herein provides a method in which a server can respond to a request from a client when the request specifies an invalid resource identifier, for example, a resource identifier referring to an incorrect or expired address, path, or location of a computer resource. When an invalid resource identifier is received by a network server (server), one or more portions of the resource identifier can be provided to a search engine as one or more keywords. The search engine can use the keywords to perform a search and return search results which can be presented to a user. Notably, the search results can be a selection of resource identifiers that link to computer resources that are likely to be relevant to the computer resource the user originally intended to access when the request was generated. For example, a list of uniform resource identifiers (URIs) can be presented to the user.

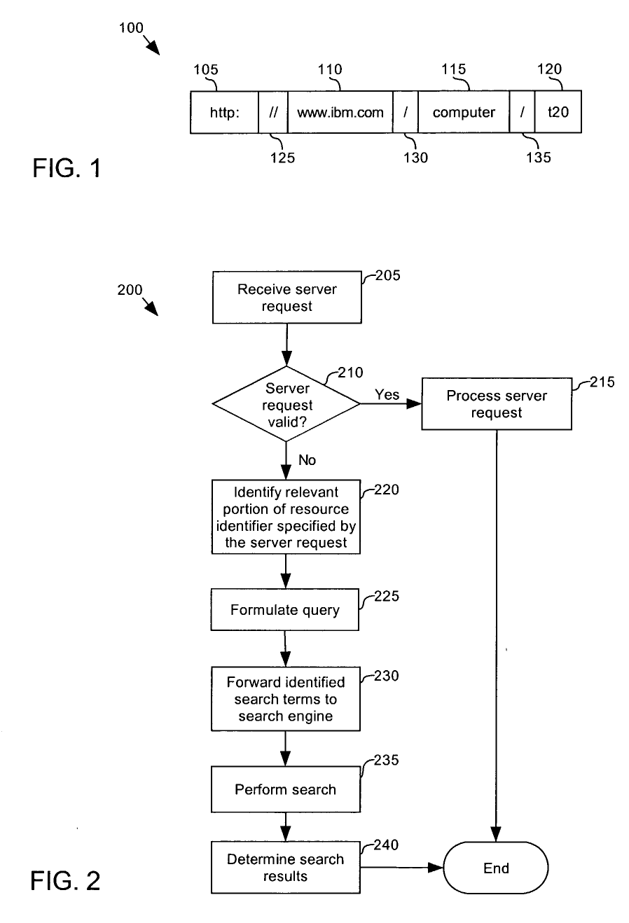

FIG. 1 shows an exemplary resource identifier 100 that a client can send to a server. The resource identifier 100 can be a URI that includes a transfer protocol identifier 105, such as a hypertext transfer protocol (HTTP) identifier or file transfer protocol (FTP) identifier, and a domain name 110 for a network server, for example “www.ibm.com.” Subsequent portions 115 and 120 of the resource identifier 100 following the domain name 110 can be provided to identify a particular path for directories and computer resources provided by the server. For example, the portions 115 and 120 can identify a directory on the server named “computer” having therein a computer resource named “t20”, for example a Hypertext Markup Language (HTML) document.

The transfer protocol 105 and domain name 110 typically are separated by double forward slashes (//) 125, while the domain name 110 and subsequent portions 115 and 120 of the resource identifier 100 typically are separated from each other by single forward slashes (/) 130 and 135 respectively. Forward slashes also can be used to identify any number of additional directories and subdirectories within a resource identifier 100. For example, as shown in FIG. 1, “computer” is the name of a directory and “t20” is the name of a computer resource contained within the “computer” directory.

If the subsequent portions 115 and 120 of the resource identifier 100 do not correlate to a valid path and/or computer resource, these portions can be used as the keywords in a search. Notably, as defined herein, a computer resource can include any data item such as a program, markup language or other electronic document, multimedia file, and/or any other network accessible software object, or collection of the same, which is accessible from a server using a client computer system.

When a resource identifier is entered into a client, the client can parse the resource identifier to identify the transfer protocol, the domain name, and specific path and/or addressing information. For example, “http://www.ibm.com/computer/t20” can be entered into a browser as a uniform resource locator (URL) which corresponds to a more specific form of a URI representing Web page addresses in the HTTP protocol. The browser can parse the URL and identify “HTTP” as the transfer protocol, “www.ibm.com” as the domain name, and “computer/t20” as the path for a specific computer resource. The domain name then can be communicated to a name server, for example a domain name server (DNS), which can translate the domain name 110 into a valid Internet protocol (IP) address. The client can receive the domain name from the name server and send the entire resource identifier in a request to the server at the determined IP address. Using HTTP, for example, the client can send the request to the server in the form of a GET request which queries the server for a particular computer resource.

Referring to flowchart 200 of FIG. 2, and more particularly to step 205, the server can receive the request from the client. For example the request can be received over a communications network such as the Internet. Referring to decision block 210, the server can determine whether the request is valid, and more particularly, whether the request contains a valid resource identifier. For instance, the server can determine whether a path specified by the resource identifier refers to an existing computer resource. If the request is valid, the server can process the request as shown in step 215. If the request is invalid, for example, if the path specified by the resource identifier does not match a known directory and/or file available on the server or refers to an expired or non-existent computer resource or address, the method can continue to step 220.

Referring to step 220, if the resource identifier specified by the request is invalid, the server can identify one or more portions of the resource identifier as a search term which can be used to search for computer resources relating to, if not the same as, the intended or desired computer resource. That is, rather than generating an HTTP 404 error message, the server can initiate a search. For example, if an invalid resource identifier specifies, at least in part, the path “/computer/t20”, the “computer” and “t20” terms may be used as search terms. Accordingly, a particular model of computer such as “t20” specified by an invalid resource identifier can be identified and provided to the search engine as a keyword so that a search for references and/or computer resources related to the particular computer can be performed.

Notably, the server can identify each portion of the resource identifier, including terms following the domain name and being separated by single forward slashes, as a search term. Still, portions of the domain name itself can be identified as search terms and parsed based upon the positioning of forward slashes and periods (.) contained therein. For example, the term “IBM” can be used as a search term alone or in combination with other identified terms. Regardless of the search terms identified, those skilled in the art will recognize that each portion or term specified by a resource identifier can be used as a search term either alone, or in combination with other identified portions of the resource identifier.

According to another embodiment of the present invention, selected portions of the resource identifier can be identified as being more relevant to the desired computer resource than others. For example, relevant portions of the resource identifier can be defined as those portions of the resource identifier which immediately follow the domain name. For example, domain names typically end with an identifier known as a Web extension, such as “.com”, “.edu”, “.gov”, “.net”, “.bus”, or any other extension that can be used to identify a domain. Accordingly, any portion of the resource identifier following a Web extension can be identified as a relevant portion. Notably, as such a term typically specifies a high level directory, the term can provide a high level description of the computer resource being sought—that is, the computer resource corresponding to the invalid computer resource identifier. Still, relevancy can be specified on a sliding scale wherein portions of the resource identifier located closer to the domain (further left) than others are assigned increasingly greater relevancy.

In another arrangement, the server can identify relevant portions of the resource identifier as those portions which are located further to the right of the domain name. In that case, the right-most term, the term having an extension such as “.htm”, “.html”, or some other file type association, can be assigned the greatest relevance. Similar to the previous embodiment, relevancy can be assigned on a sliding scale wherein relevancy increases as terms are located further to the right.

In yet another embodiment of the invention, any identified portions of a resource identifier can be compared to a dictionary specifying valid terms and/or rules specifying valid terms. Comparison of potential search terms to a dictionary of valid terms enables the server to discard irrelevant or nonsensical terms, thereby increasing the effectiveness of a search. For example, terms which include symbols, numbers, or other non-letter characters can be discarded. Still, the dictionary can include particular product identifiers, such that selected terms identifying products, i.e., “t20”, can be defined and/or specified as allowable terms. Notably, the dictionary also can specify relevancy rules for the various entries contained therein. Accordingly, terms such as “t20” which may identify a specific product can be defined as having high relevancy. Relevancy also can be defined on a search term's part of speech, for example depending upon whether the search term is a noun, verb, adjective, or the like.

Referring to step 225, the identified search terms extracted from the resource identifier can be combined to form a query to be provided to a search engine. If a plurality of search terms are identified from the resource identifier, one or more search operators can be used to combine the relevant portions into an expression that can be used to perform a valid search. For example, boolean expressions, as well as other search engine operators, can be used to combine the identified search terms into a valid expression. For instance, the terms “computer” and “t20” can be combined with an “AND” boolean expression. Hence the search expression then becomes “computer AND t20”.

Notably, the dictionary and/or rules contained therein can specify how searches are to be specified. For example, rules can state that a specific term is to be linked to a more general term using an “and” boolean operator or an operator specifying that the terms are to be located within a predetermined range of one another, while two general terms, or two specific terms, are to be linked using an “or” operator.

Further, when multiple portions of a resource identifier are provided as keywords for a search, one or more of the keywords can be associated with a weighting factor indicative of the relevance of the search term as previously discussed. The weighting factors can be used to specify frequency of a search term within a reference or can be used to indirectly specify the type of operator linking particular keywords of a search. For example, a highly relevant keyword can be connected with other keywords using an “and” operator rather than an “or” operator. Less relevant keywords can be linked to more significant words using a “within x words” operator or an “or” operator.

For example, the keywords can be weighted according to the position of the keyword within the resource identifier prior to extraction. In illustration, those keywords located in the rightmost portion of a resource identifier can be assigned the greatest weight, while keywords extracted from positions to the left of the rightmost portion can be assigned ever decreasing weights. Similarly, the weighting of the keywords can be determined by the dictionary wherein keywords determined to be more relevant can be weighted more heavily than less relevant keywords. Hence, as the term “t20” represents a particular computer model and the term “computer” is more generic, the term “t20” can be assigned greater weight as a keyword than the term “computer.” Still, other algorithms can be used for weighting keywords. For instance, keywords can be weighted according to the part of speech with which the keyword is associated. In any case, the invention is not limited to those examples contained herein.

In step 230, the query, whether a single keyword or multiple keywords, can be sent to a search engine. In step 235, the search engine can perform a search as specified by the received query. The search engine can use the search terms to search for computer resources that are likely to correlate to the computer resource the user intended to access when the invalid resource identifier was specified. Notably, the search engine can be local to the server having received the invalid request. Accordingly, the search can be limited to searching only those computer resources contained on the server or having a domain common to the resource identifier specified by the invalid request.

Alternatively, the search engine can be remotely located from the server and search other computer systems and/or data stores accessible over a communications network. For example, the search can be expanded to cover computer resources available over an entire network or the Internet. Still, the search engine can pass the keyword and/or keywords to other search engines to perform multiple searches. The search can be performed by searching the contents of computer resources, metadata, stored computer resource attributes, and the like. As the search can be performed using any of a variety of search techniques, the present invention is not limited to a particular search methodology.

Referring to step 240, the search engine can determine search results, which can be sent to the client for presentation to the user. The search results can be presented in a standard output format, for example, as links to the computer resources found during the search. Further, the links can be listed in a particular sequence. For example, the links can be presented alphabetically, by file type, by order of likely relevance, or by any other listing precedence. Still, a single resource identifier determined to be the most relevant when compared to the incorrect resource identifier can be presented to the user. Alternatively, the computer resource corresponding to the determined resource identifier can be presented. If no computer resources are found by the search, the user can be notified accordingly.

The present invention provides a solution for handling invalid resource identifiers within a server. In particular, rather than generating an HTTP 404 error message, a server can search for other computer resources within the server or same domain that may satisfy the user query. Accordingly, those skilled in the art will recognize that the particular methodology and/or techniques used with regard to formulating a query and searching in general can vary. As such, the examples disclosed herein are for purposes of illustration and are not intended as a limitation of the present invention.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for responding to a request from a client, comprising the steps of:
determining whether said request received from said client is valid;
if said request is invalid, identifying at least one portion of a resource identifier specified by said request as a search term; and
searching for a computer resource associated with said at least one portion of a resource identifier specified by said invalid request.

2. The method of claim 1, wherein said searching step is confined to a domain specified by said resource identifier of said invalid request.

3. The method of claim 2, wherein said searching step is confined to a server having received said invalid request.

4. The method of claim 1, further comprising:
identifying a computer resource associated with said identified portion of said resource identifier responsive to said searching step.

5. The method of claim 4, further comprising:
sending a resource identifier associated with said identified computer resource to said client for presentation.

6. The method of claim 4, further comprising:
sending said identified computer resource to said client for presentation.

7. The method of claim 1, said determining step further comprising:
determining whether said resource identifier specified by said request identifies an existing computer resource.

8. The method of claim 1, further comprising:
validating said at least one portion of said resource identifier using a dictionary specifying valid search terms.

9. The method of claim 1, said identifying step comprising:
identifying a portion in said resource identifier following a leftmost forward slash (/) that is not immediately adjacent to another forward slash.

10. The method of claim 1, said identifying step comprising:
identifying a portion in said resource identifier following a Web extension.

11. The method of claim 1, wherein said first and a second portion of said resource identifier are identified as search terms, said method further comprising:
combining said first portion and said second portion with an operator to form a search expression for said search.

12. The method of claim 11, further comprising:
associating said first portion and said second portion with respective weighting factors for said search.

13. The method of claim 12, said associating step further comprising:
determining said weighting factors by a location of said selected portions in said resource identifier.

14. The method of claim 12, said associating step further comprising:
determining said weighting factors by a specificity of at least one term in said selected portions.

15. The method of claim 1, said providing step further comprising:
providing said selected portion as a keyword to at least two search engines.

16. A machine-readable storage, having stored thereon a computer program having a plurality of code sections executable by a machine for causing the machine to perform the steps of:
determining whether said request received from said client is valid;
if said request is invalid, identifying at least one portion of a resource identifier specified by said request as a search term; and
searching for a computer resource associated with said at least one portion of a resource identifier specified by said invalid request.

17. The machine-readable storage of claim 16, wherein said searching step is confined to a domain specified by said resource identifier of said invalid request.

18. The machine-readable storage of claim 17, wherein said searching step is confined to a server having received said invalid request.

19. The machine-readable storage of claim 16, further comprising:
identifying a computer resource associated with said identified portion of said resource identifier responsive to said searching step.

20. The machine-readable storage of claim 19, further comprising:
sending a resource identifier associated with said identified computer resource to said client for presentation.

21. The machine-readable storage of claim 19, further comprising:
sending said identified computer resource to said client for presentation.

22. The machine-readable storage of claim 16, said determining step further comprising:
determining whether said resource identifier specified by said request identifies an existing computer resource.

23. The machine-readable storage of claim 16, further comprising:
validating said at least one portion of said resource identifier using a dictionary specifying valid search terms.

24. The machine-readable storage of claim 16, said identifying step comprising:
identifying a portion in said resource identifier following a leftmost forward slash (/) that is not immediately adjacent to another forward slash.

25. The machine-readable storage of claim 16, said identifying step comprising:
identifying a portion in said resource identifier following a Web extension.

26. The machine-readable storage of claim 16, wherein said first and a second portion of said resource identifier are identified as search terms, said method further comprising:
combining said first portion and said second portion with an operator to form a search expression for said search.

27. The machine-readable storage of claim 26, further comprising:
associating said first portion and said second portion with respective weighting factors for said search.

28. The machine-readable storage of claim 27, said associating step further comprising:
determining said weighting factors by a location of said selected portions in said resource identifier.

29. The machine-readable storage of claim 27, said associating step further comprising:
determining said weighting factors by a specificity of at least one term in said selected portions.

30. The machine-readable storage of claim 16, said providing step further comprising:
providing said selected portion as a keyword to at least two search engines.
